(19) United States
(12) Patent Application Publication
(10) Pub. No.: US 2010/0085761 A1
(43) Pub. Date: Apr. 8, 2010

(54) REFLECTOR ASSEMBLY AND BEAM FORMING APPARATUS

(75) Inventor: Michael Fernand Alexander Derome, Farnborough (GB)

Correspondence Address: OLIFF & BERRIDGE, PLC, P.O. BOX 320850, ALEXANDRIA, VA, 22320-4850, US

(73) Assignee: QINETIQ LIMITED, London (GB)

(21) Appl. No.: 12/514,651

(22) PCT Filed: Nov. 23, 2007
(86) PCT No.: PCT/GB07/04496

§ 371 Date: Dec. 3, 2009

(30) Foreign Application Priority Data
Nov. 29, 2006 (GB) 0623796.0

(51) Int. Cl. G02B 5/10; F21V 7/00

(52) U.S. Cl. 362/298; 359/853

(57) ABSTRACT

A reflector assembly for use with a paraboidal reflector comprises a generally-cylindrical body (302) having a plurality of stepped facets (306) extending circumferentially around its internal surface. Each facet serves to reflect divergent light from a light source (308) back onto the primary reflector (314) for re-reflection thereby enhancing the beam produced. Such a reflector can be used with existing lamps or alternatively a purpose built composite reflector incorporating such an element can be designed.

The present invention relates to a reflector assembly, and particularly, but not exclusively to an assembly for use with a conventional lamp or light source including a paraboloidal reflector.

Paraboloidal reflectors are perhaps the most common way light from a source such as a lamp or filament is concentrated into a beam. Design constraints such as overall shape or size often dictate the lamp parameters resulting in sub optimal beams. Vehicle headlamps in particular often have to fit into a particular envelope and result in a complex unit including multiple reflectors.

U.S. Pat. No. 4,794,504 discloses a vehicle headlight assembly in which the reflector is truncated by upper and lower planes. The document proposes reflectors arranged on the lower face of the assembly to improve the light output.

It is an object of one aspect of the invention to provide a simple and inexpensive apparatus which can be retrofitted to a lamp to improve light concentration properties.

According to a first aspect of the invention therefore, there is provided a reflector assembly comprising a generally tubular body having a light input end and a light output end, and having a plurality of stepped, axially spaced reflecting elements extending circumferentially around the internal surface of said body and inclined towards said input end.

The assembly is conveniently adapted to be fitted to a beam forming device having a light source and a primary reflector. In this way, a beam from the light source can enter the input end and exit the output end with a defined beam spread, or divergence, determined by a combination of the primary reflector and the reflector assembly. The reflecting elements of such an embodiment are adapted to catch and reflect light, the divergence of which is greater than desired. Light incident upon the internal surface of the reflector body is therefore reflected back onto the primary reflector, to be combined with the desired beam thus increasing its intensity.

Such an apparatus is simple to manufacture and can easily be retrofitted onto an existing beam forming device, typically a torch or flashlight to increase the amount of light concentrated into the beam. Substantially any light source can be accommodated, and heat build up, which can affect prior art techniques can be mitigated.

By careful design, and as will be described in greater detail below, the reflector body can be matched to a beam forming device such that none of the rays reflected from the primary reflector are impinged by the body, and only light rays from said light source which emerge unreflected by said primary reflector are redirected by the reflecting elements.

By arranging the reflecting elements around the entire circumference of the inside of the body, a high proportion of the light from the light source which would otherwise be ‘lost’ is redirected back into the desired beam.

Preferably the reflecting elements all have substantially the same focal point, and the arrangement is preferably such that light from a light source incident on a reflecting element is reflected back towards that light source.

In one embodiment the body is substantially cylindrical, and the reflecting elements are annular. Alternatively, the elements may define a helix having a shallow pitch.

Embodiments of the invention include fastenings for attaching the assembly to a beam forming device. These may be latches or screws designed to engage with cooperating fixtures, or alternatively a ‘universal’ rubber bush or the like may be used to allow the assembly to be attached to a range of devices via a simple push fit. The assembly can be removable, and can be switched in and out of use quickly and easily by a user as desired.

The thickness of said tubular body is conveniently less than or equal to 15% of said body diameter, more conveniently less than 10% or even 5%. The length of the body is preferably greater than or equal to the body diameter.

A further aspect of the invention provides beam forming apparatus comprising a beam source including a light source and a primary reflector arranged about said light source for producing a beam along a beam axis, and a secondary reflector comprising one or more reflecting elements arranged circumferentially around a central aperture, wherein said secondary reflector is arranged for said beam to pass through said central aperture and adapted to reflect light from said source onto said primary reflector.

preferably the secondary reflector is arranged to reflect only rays from said light source which emerge unreflected by said primary reflector.

The primary reflector typically has a rim at its open end, and it is advantageous for the aperture of the secondary reflector to be substantially the same size as the rim of the primary reflector. Where the primary reflector is paraboidal, the rim will have a diameter, and the aperture of the secondary reflector will typically be a circle with substantially the same diameter, however more generally, the aperture will be the same size as the rim, perpendicular to the beam axis, or axis of rotation of the lamp. This minimises the overall dimension of the secondary reflector while still allowing most or all of the light from the primary reflector to pass through the aperture unaffected.

It is convenient for the secondary reflector to comprise a plurality of reflector elements. These elements preferably all have substantially the same size, that is, substantially the same cross section perpendicular to the beam axis, and are preferably axially spaced so as to define en elongate hollow envelope. In apparatus according to such an embodiment, the secondary reflector can be considered to form a tube, having a plurality of reflective elements on its inside surface, with the beam passing through the centre of the tube.

Typically, the rim of the primary reflector will have a thickness, with the external dimension of the rim defining a casing of the beam forming apparatus eg a hand held torch, or flashlight. Advantageously the reflector elements are substantially the same size as, or smaller than the rim, taken in section perpendicular to the beam axis. In this way the ‘footprint’ of the secondary reflector, considered perpendicular to the beam axis, can be substantially the same size as, or smaller than the rim of the primary reflector. In the example of a hand held torch, the secondary reflector can be included in the outer casing, without causing any substantial increase in the overall diameter of the torch. Where a device is retrofitted to a torch for example, only the length of the torch need be extended, and the device can be made to blend into the profile of the torch.

Preferably the primary reflector is a paraboloid, and preferably the secondary reflector is paraboloidal or spherical, or comprises a series of elements providing the effect of a paraboloidal reflector, coaxial with said first reflector, conveniently a spherical reflector whose centre is substantially at or adjacent to the axial point source. Preferably, the secondary reflector is a cylindrical fresnel reflector.

Advantageously, the secondary reflector has substantially the same external diameter as said primary reflector

The invention also provides, in an additional aspect, the use of a reflector assembly according to the first aspect for increasing the intensity of a light beam from a beam forming device comprising a light source and a primary reflector.

A further aspect of the invention provides a reflector comprising a generally tubular internally reflective body arranged along a longitudinal axis and having a light output aperture and a source entry aperture, said reflector adapted to receive a light source through said source input aperture, and to generate a beam from said light output aperture, wherein said reflector comprises a rear dished region having a varying cross section, and a forward prismatic region having a substantially constant cross section.

In many embodiments, the first region is paraboloidal or an ellipsoidal. The first region is preferably relatively shallow having a ratio of focal length to maximum radius of greater than 0.3, and more preferably greater than 0.4, resulting in a relatively large source-reflector separation. It can be shown that in a particularly advantageous embodiment the ratio is substantially 0.5. Preferably the ratio is less than 0.6

The invention extends to methods and/or apparatus substantially as herein described with reference to the accompanying drawings.

Any feature in one aspect of the invention may be applied to other aspects of the invention, in any appropriate combination.

Preferred features of the present invention will now be described, purely by way of example, with reference to the accompanying drawings, in which:

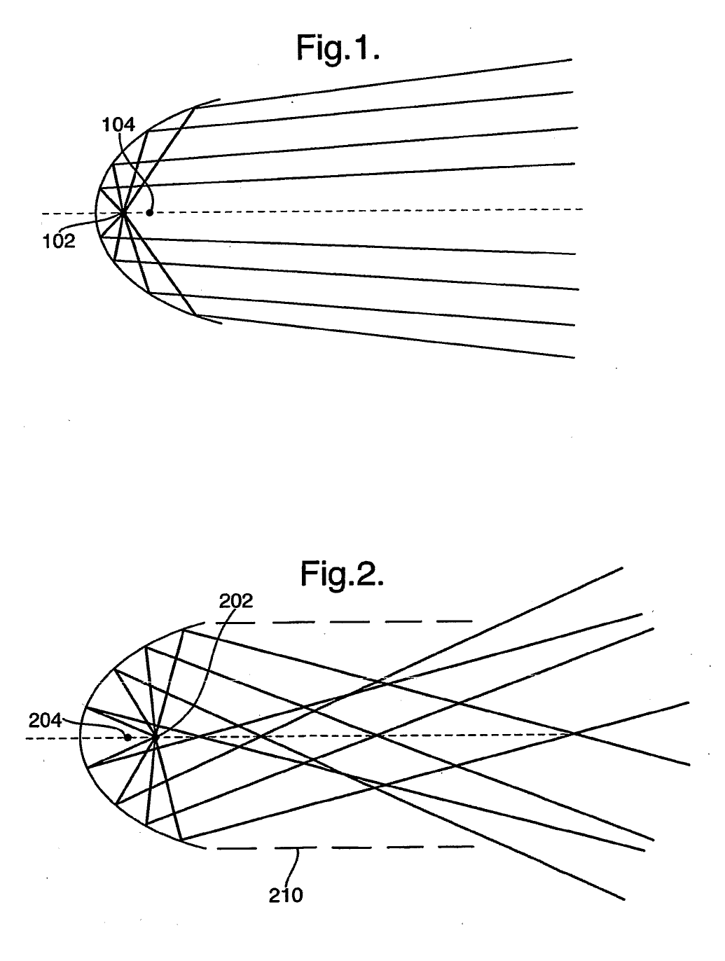

FIG. 1 shows a paraboloidal reflector with a light source behind the focal point

FIG. 2 shows the same reflector with a light source in front of the focal point

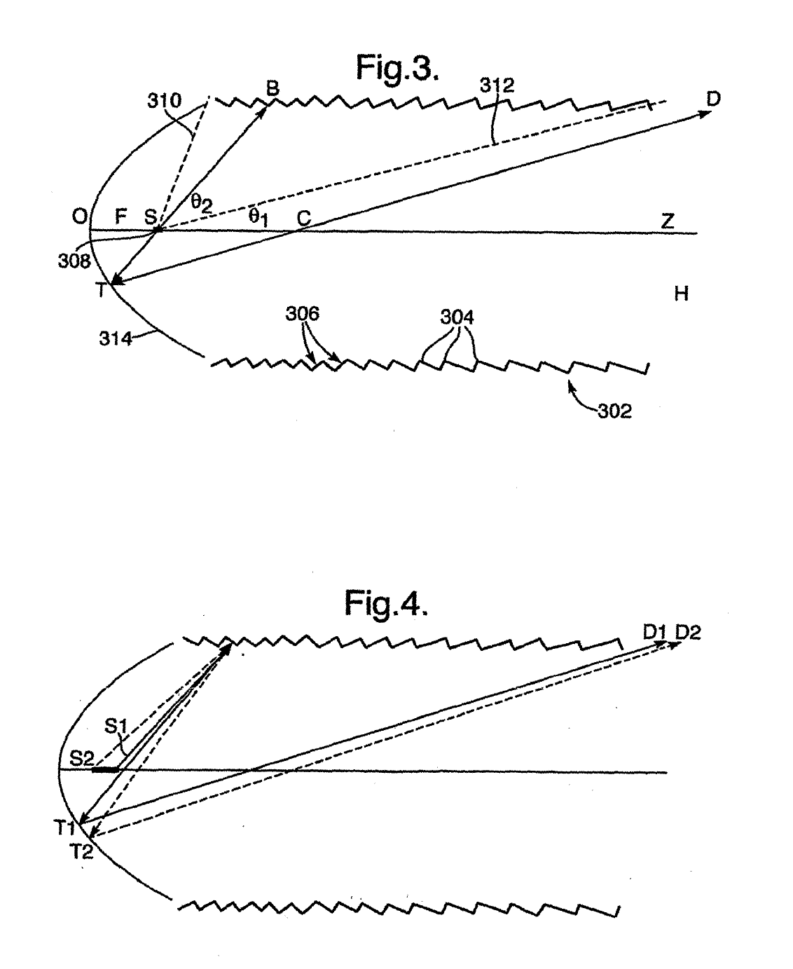

FIG. 3 shows an embodiment of the invention with a point light source

FIG. 4 shows an embodiment of the invention with a line light source

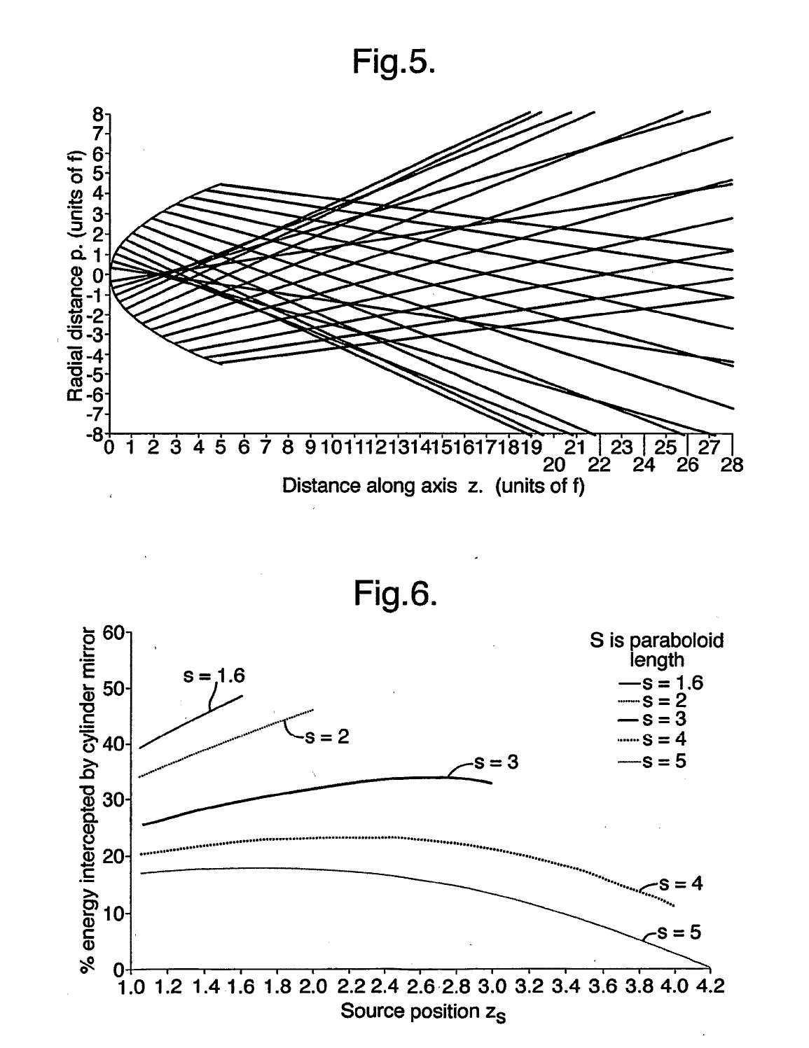

FIG. 5 shows a ray plot for a particular reflector geometry

FIG. 6 shows energy intercepted by embodiments of the present invention for varying reflector geometries

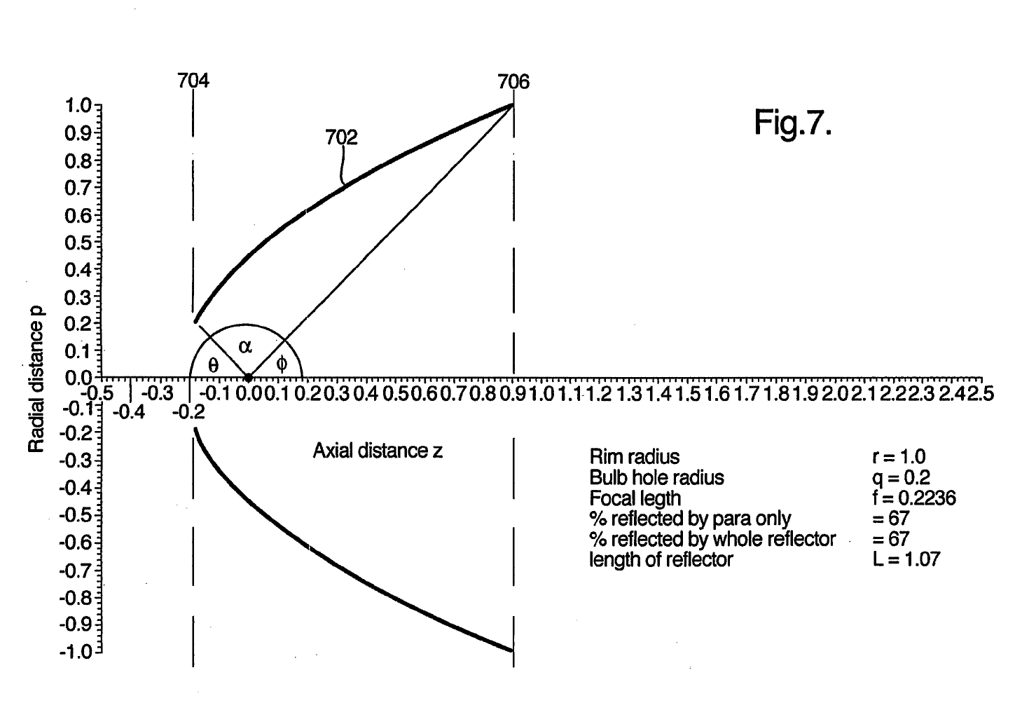

FIG. 7 shows a parabolic reflector arrangement

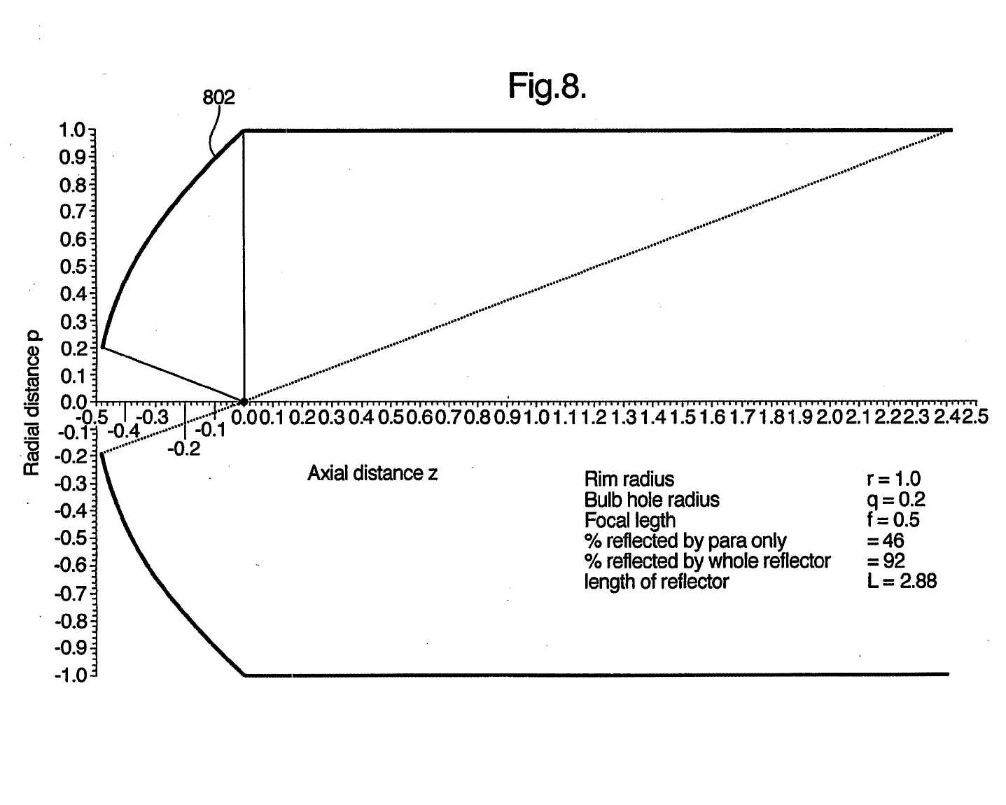

FIG. 8 shows a composite reflector arrangement

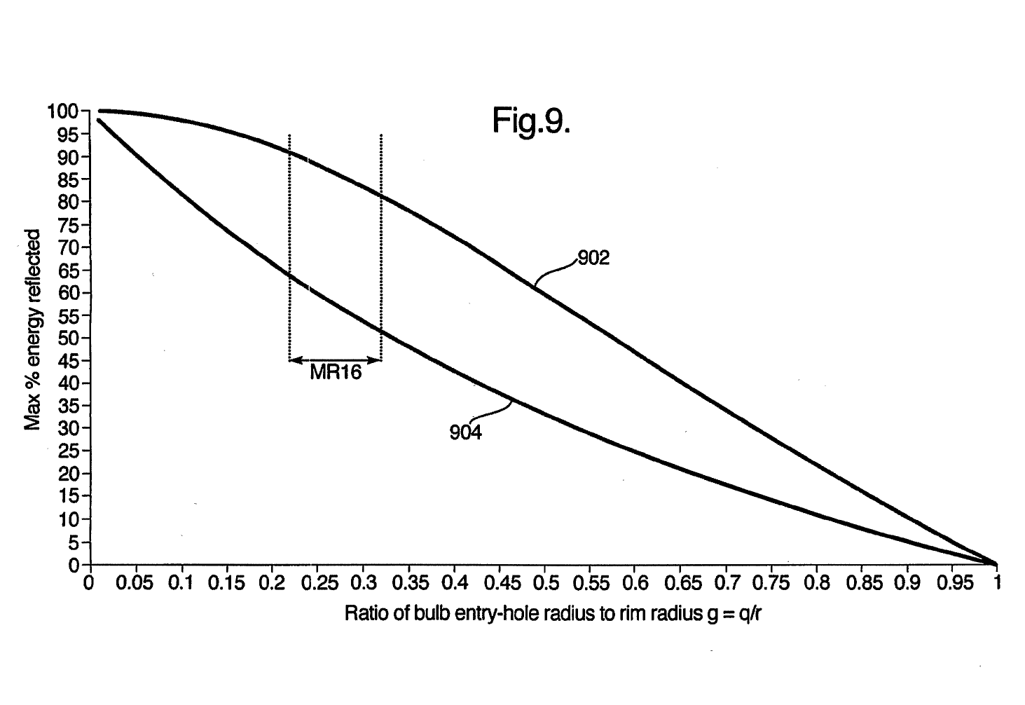

FIG. 9 illustrates theoretical efficiencies for the reflectors of FIGS. 7 and 8

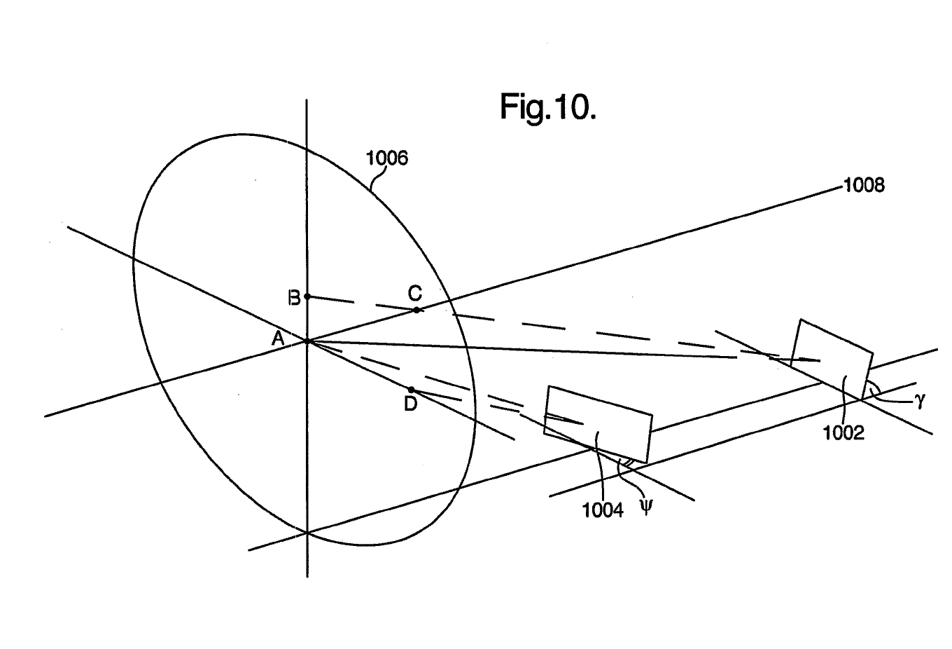

FIG. 10 illustrates various inclination angles of reflector elements

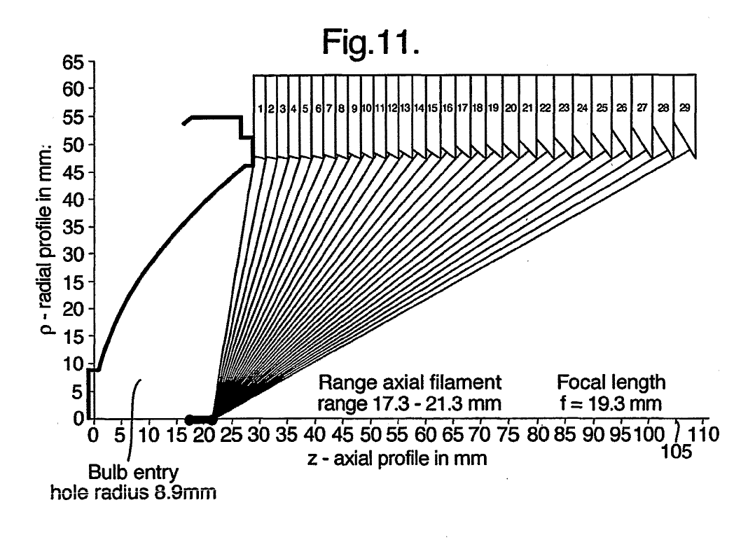

FIG. 11 shows the construction of a reflector arrangement.

A well known design of lamp includes a reflector, typically a paraboloidal reflector, placed behind a light source, in order to form a concentrated beam along an axis. The light source 102 in FIG. 1, may be placed between the base of the reflector and the focal point, 104 of the reflector (often denoted “behind” the focus), in which case all light rays are divergent after reflection. More commonly, the light source 202 in FIG. 2, is arranged beyond the focal point 204 of the reflector (often denoted “in front” of the focus) in which case reflected light rays initially converge, and then diverge after they have crossed the axis. The distance from the base of the reflector to the light source 202 along the beam axis, is designated Zs, and referred to as the source length and is typically given in units normalised by the focal length (the distance from the base of the reflector to the focal point).

Considering the latter case, there is a region where the cross section of the beam has a radius or “neck” smaller than that of the lamp at its open end in the form of a cylindrical surface, shown in dashed line as 210, whose radius r is the same as the lamp at its open end, and through which reflected rays do not pass.

A schematic of an embodiment of the invention, which assumes the source is a point on the axis, is shown in FIG. 3. A tubular body 302 is positioned in place of the imaginary cylinder described above. The inside surface of the tubular body consists of a series of stepped ridges 304. Annular mirror elements 306 are provided on the inclined surfaces facing the light source 308. Previously un-reflected rays emitted from a point source S (a hot filament, arc or LED) between the two cones 310, 312, are reflected by the stepped mirror, back close to the source S and subsequently are reflected a second time by the paraboloidal mirror 314. An example ray path is shown as travelling from source S to mirror facet B back “through” S onto the parabolidal mirror at T and out towards D. The twice reflected light is now concentrated and joins the main, singly reflected beam, to produce a total beam brighter than the original singly reflected beam. Concentration of a doubly reflected beam is achieved if the angle of an output ray, DCZ for example, is smaller than that of the input ray, BSZ. The length of the cylinder is chosen such that it does not interfere with the original beam nor with the twice reflected light. An approximate example of this design is the type of miniature halogens which has a short transverse filament.

A schematic of a more complex design, which assumes the source is a line along the axis, is shown in FIG. 4. Rays from extreme points on the source, extending from S1 to S2, are reflected back to miss the most “forward” part of the source before undergoing the second reflections. An example of this design is the type of miniature halogens which has an axial filament. The result of an extended axial source can be derived from the results by considering a line of point sources as an approximation for a line source. It is often sufficient to consider the two points at each end of the line source.

In real incandescent lamps, such as low voltage miniature halogen lamps the lamp reflector is predominantly paraboloid but is faceted rather than completely smooth. In high quality incandescent filament lamps giving the most controlled beams, the filament is axial. Cheaper ones, giving a less even beam use transverse filaments which are not rotationally symmetric. Xenon arc lamps use a small approximately spherical region of hot gas as a source which is still rotationally symmetric. A final design would take these effects into account but the designs described here will still provide a result close to that predicted.

The maximum length of the ‘neck’ or cylindrical surface described above, and hence of the tubular body depends on the source position and lamp's open-end radius, and can be determined mathematically. Generally speaking, the maximum cylinder length falls with increasing distance of the source from the base of the reflector. For an extended axial source, such as is shown in FIG. 4, the largest axial source position (at S2) should be used to calculate maximum cylinder length

The actual length of a cylinder mirror may be chosen to be smaller than the maximum, based on the ideal design, because after two reflections rays should not hit the cylinder mirror again. As is illustrated in FIG. 4, rays following two reflections cross the axis “ahead” of the furthest forward point of the light source. These crossover points can be considered as virtual sources and used as source points to predict where they cross the cylinder. The minimum axial distance at which they do so will determine the cylinder mirror's actual length.

FIG. 5 shows rays reflected from a paraboloidal mirror of radius 4.5f, where f is the focal length of the paraboloid, for a point source at 2f along the z axis (typical for a narrow beam MR16 type miniature halogen reflector lamp). In this example the maximum length of the cylinder mirror is predicted to be about 7f., between z=5 and z=12 in FIG. 5. In a typical narrow to medium beam spotlight the source position varies from 1.0f to about 2.5f. It can be seen that as the “distance along axis” z_{T} at which reflection occurs (ie the point on the parabola at which the light from the source is incident) increases, the angle a reflected ray makes with the axis of the parabola (called the emergence angle) first increases, reaches a maximum and then decreases. This behaviour is the reason the beam has the “neck” referred to above, which the invention exploits.

Ideally the size of the mirror elements should be larger than the wavelength of light to avoid diffraction effects. If they are too large however, the spread of rays reflected from a single element will be too large to achieve suitable concentration of the output beam. Initial calculations suggest that for a paraboloid radius of the order 20 mm the step depth should be of the order 0.1-0.5 mm. Allowance should be made for finite source size and angle tolerances achievable on the cylinder mirror facets.

An internally stepped component as described above can be produced, for example by machining a series of rings, each having an appropriately bevelled internal edge, and staking the rings together in order. Stereolithography or other rapid prototyping technologies could also be employed to generate the desired form to a suitable degree of accuracy. Subsequently the form could be used to produce a mould. An example of a stepped component formed from a series of stacked rings is shown in FIG. 11. Here 29 rings are used, although practical designs might employ as little as 10 or more facets, depending on the application. The inner radius of the rings (ie at the sharp point) in this example is approximately 47 mm, and the outer radius is at least 55 mm and is shown as approximately 62 mm. The thickness and bevel angle of each ring varies along the length of the reflector, such that incident light from the furthest point of the elongate source strikes approximately the last 2 mm of each facet, substantially perpendicular to the facet.

The maximum fraction of previously un-reflected light energy which can be captured by the stepped cylinder mirror can be calculated from the geometry of the lamp if it is assumed that the stepped cylinder mirror is made the same diameter as the lamp and is of maximum length, and that the source is a point source on the axis, emitting light homogeneously in all directions.

Formulae specifying the fraction of capturable energy as function of source position can be derived, however FIG. 6 shows plots of capturable energy as function of source position for different paraboloid lengths, s. The curves are not drawn for source position z_{S} exceeding the length of the paraboloid.

For existing MR16 lamps maximum source length z_{S} ranges from about 1.0f to 2.4f and have length s˜5.1. (radius=2√5.1=4.5). The energy capturable by a cylinder mirror is of the order 17%. For a deeper, i.e. longer paraboloid torches length is about 6.0f which equates to about 8% un-reflected capturable energy.

In the previous examples, attention has been directed at improving the performance of existing lamp and reflector designs. However aspects of the invention can be exploited to provide novel reflector designs having improved performance over existing designs. For example, an advantageous design for high beam concentration has been found to have a short paraboloid, allowing a high proportion of emitted energy to be available for re-reflection, resulting in a smaller overall lamp radius for a given beam intensity (lamp radius reduces with diminishing paraboloid length).

To exploit this aspect of the invention more fully practical reflector constraints need to be considered. Common lamp designs, intended to produce a narrow beam of light from a small bright light source, use predominately paraboloidal or ellipsoidal reflectors in which the bulb containing the light source, for example a filament or high intensity discharge tube, is constrained to enter the reflector through an aperture in its base.

Important design constraints are the size of the bulb aperture at one end of the reflector and the size of the output aperture, often circular, at the other. Having fixed the size of bulb-entry aperture and output aperture or lamp diameter, there is still a free choice for the focal length f of the paraboloid. The narrowest beam for a paraboloidal reflector is achieved when the finite size source is centered on the focus. For an ellipsoidal reflector light from the “base” focus is reflected towards and through a second focus further along the lamp's axis. In practice the finite size of any light source causes light to be reflected over a range of angles. For a fixed size of bulb-entry hole and lamp diameter, there is still a free choice for the focal length f of the paraboloid. If the two apertures are assumed circular it can be shown that, for a point source placed at the focus, there is a particular focal length fp for which the maximum possible fraction of light is reflected. This maximum focal length fp and the fraction of reflected light depend on the hole diameters. A reflector with focal length fp can hence be referred to as a maximum energy paraboloid. An example of such a maximum energy paraboliod with a source at the focal point is shown in FIG. 7.

The paraboloidal reflector 702 is truncated by two planes 704, 706 perpendicular to its axis of symmetry, cutting it to form two circles. The smaller circle, of radius q, nearest the base of the paraboloid is to accommodate the bulb fitting. Light emerges through the larger circle, which forms the open end of the lamp, of radius r. Light reflected from the paraboloid emerges parallel with the axis between cylinders of radius q and radius r, which can be seen to correspond to light emerging from the source within solid angle α. If the parabola length is extended in an attempt to increase the proportion of light reflected, ie to decrease angle φ, then the focus necessarily moves closer to the rear plane 704. This in turn increases angle θ increasing light ‘lost’ through the source entry aperture, and decreasing the total amount of light reflected. Conversely, an attempt to decrease angle θ increases angle φ, again moving away from the maximum percentage of light reflected. Thus the actual fraction of energy reflected and the focal length depend only on the ratio g, of q to r.

Measurements on commercially available reflectors show some are close to being maximum energy paraboloids, for example many of popular MR16 halogen reflector varieties. The shape of the bulb aperture for these is rounded-corner rectangle. The measured focal lengths correspond with values for a bulb-hole radius q having a value between the long and short dimensions of the actual bulb entry-hole shape.

FIG. 8 shows a novel reflector embodying an aspect of the present invention, having the same ratio g, of q to r as that of FIG. 7.

The reflector of FIG. 8 consists of a generally tubular body made up of two component regions. The first region consists of a paraboloidal reflector 802 having the point light source at its focus and having the same source entry aperture radius q and same light output aperture radius r as in the first design, but having a longer focal length. The second region comprises a cylinder, having substantially the same constant radius as the output aperture radius r. The inside surface of the cylinder consists of multiple mirror facets having the idealized property that any light ray emitted from the focus which hits them is reflected back along its path, as described above. Light reflected from the paraboloid, after one or two reflections, emerges parallel with the axis between cylinders of radius q and radius r just as in the first design.

It can be shown that for given dimensions q and r, there exists an optimum length of cylinder mirror Lcyl, for which there is a maximum in the fraction of light reflected at a particular focal length. A reflector as illustrated in FIG. 8 having these properties is hence referred to as a maximum energy composite reflector. Again the actual fraction of energy reflected depends only on the ratio g of q to r.

The fractions of energy reflected from these two maximum energy designs for various value of g are compared in FIG. 9. Curve 902 corresponds to the maximal composite reflector, and can be seen to provide an efficiency greater than that of a maximal paraboloidal reflector (curve 904) for all values of g. Typical values of g for MR16 lamps of between approximately 0.22 and 0.32 are indicated, and it can be seen that in this region the composite maximal design returns values of 80 to 90% energy reflected whereas the maximal paraboloidal design returns corresponding values of only 50 to 65%. A comparison of the fractions of energy reflected for both maximum energy designs provides a comparison of light intensity of the two because the energy falling on a plane perpendicular with the axis will fall between circles of radius q and r. Therefore it can be seen that greater light intensity is achieved by the composite design than by the basic parabolic design for a given output aperture, or rim size, and source entry aperture.

It can also be shown that, while the focal length of the parabolic design increases with increasing g (in units normalised by output aperture radius r), the focal length for the maximised composite design is constant at 0.5 (ie half the rim or output aperture radius). For practical reflectors having g in the range 0 to 0.5, the focal length of the composite design is always greater than that of the paraboloidal design. Therefore the composite design provides greater separation between bulb and reflector, and consequently the reflector surface can be cooler for a given source, or conversely a more powerful source can be fitted for the same surface temperature.

As noted above, in a practical design the finite size source could interfere with reflections from the cylindrical mirror, and embodiments of the invention mitigate for this by arranging for such reflections to pass forward of the source. Since the practical axial filament of the source extends along the axis a considerable distance from the focus this meant the rays crossed the axis at a considerable distance from the focus.

Embodiments of the invention therefore, in addition to being inclined in the axial direction, have mirror elements which are inclined circumferentially, such that beams directed back towards the primary reflector “miss” the source out of plane, and do not intersect the beam axis. In this way the focus of the combined effect of the elements can effectively be broadened into a ring or circle. This arrangement can be particularly useful for elongate light sources, allowing reflected beam to pass by the ‘side’ of the source rather than in front of it.

This is illustrated in FIG. 10, where reflective facets 1002 and 1004 of a cylindrical reflector according to aspects of the invention are shown. The facets are representative of a cylindrical reflector having an envelope formed by extrusion of circular plane 1006 along axis 1008, and are exaggerated in size for ease of viewing. Both facets lie at the same circumferential position, but are spaced axially.

Facet 1002 can be seen to be inclined at an angle γ to the axis of the reflector, such that a ray emanating from point A at the centre of circular plane 1006 is reflected back to point B on the plane. Facet 1002 however has no circumferential inclination, and hence the ray from this facet to point B passes through the central axis of the reflector at point C.

Turning to Facet 1004, this is also inclined with respect to the axis of the reflector in a similar manner to facet 1002 albeit at a different angle. However it is additionally inclined circumferentially at an angle ψ, such that a ray emanating from point A is reflected back to a point D on circular plane 1006. The reflected ray from facet 1004 to D does not pass through the central axis of the reflector, ie it is reflected out of the plane containing the source, the facet itself and the reflector axis 1008. If a source located at A has a finite size, it can be seen that the two facets both reflect light to intercept the source plane 1004 at a point spaced apart from central point A, but that the direction of spacing is orthogonal.

Such reflection out of plane can be achieved by having reflecting elements arranged in a helix. Alternatively the angle of circumferential inclination could be alternated around the circumference of a single annular element, resulting in a ‘zig-zag’ facet structure, with alternate facets at a given axial position reflecting rays out of plane in opposite senses. A further possible arrangement has facets of a single annular element all circumferentially angled in the same sense, resulting in a ‘saw-tooth’ facet structure.

It will be understood that for an elongate source arranged along the axis of the reflector, directing rays out of plane to the ‘side’ as opposed to ‘in front’ of the source allows the rays to be closer to the optimal geometry, while still missing the source. Again this provides performance advantages.

It will be understood that the present invention has been described above purely by way of example, and modification of detail can be made within the scope of the invention. Although embodiments have been described principally with circular and cylindrical geometry, faceteted approximations to such geometries and other geometries, such as hexagonal, octagonal and higher order polygonal geometries are possible. Where paraboloidal reflectors are described, ellipsoidal reflectors could be employed with suitable parameters.

Each feature disclosed in the description, and (where appropriate) the claims and drawings may be provided independently or in any appropriate combination.

1. A reflector assembly comprising a generally tubular body having a light input end and a light output end, and having a plurality of stepped, axially spaced reflecting elements extending circumferentially around the internal surface of said body and inclined towards said input end, wherein normals to said elements do not intersect a central axis.

2-5. (canceled)

6. A reflector assembly according to claim 1, wherein said elements define a helix.

7. A reflector assembly according to claim 1, wherein normals to said elements all pass through a circle centered on said central axis.

8. (canceled)

9. A reflector assembly according to claim 1, wherein the diameter of said tubular body is less that or equal to said body length.

10. A reflector assembly according to claim 1, wherein said assembly is adapted to be fitted to a beam forming device having a light source and a primary reflector, such that in use a beam from said light source enters said input end and exits said output end, and wherein said reflecting elements are adapted to reflect incident light onto said primary reflector.

11. A reflector assembly according to claim 10, wherein said assembly is adapted to be fitted to a flashlight.

12. A reflector assembly according to claim 10, wherein attachment means are provided at said input end.

13. Beam forming apparatus comprising:
a beam source including a light source and a primary reflector arranged about said light source for producing a beam along a beam axis; and
a secondary reflector comprising ten or more reflecting elements arranged circumferentially around a central aperture, said elements axially spaced so as to define an elongate hollow envelope;
wherein said secondary reflector is arranged for said beam to pass through said central aperture and adapted to reflect light from said source onto said primary reflector.

14-15. (canceled)

16. Apparatus according to claim 13, wherein said primary reflector has a rim, and wherein the aperture of the secondary reflector is substantially the same size as the rim of the primary reflector.

17. (canceled)

18. Apparatus according to claim 13, wherein the reflector elements all have substantially the same size perpendicular to the beam axis.

19. (canceled)

20. Apparatus according to claim 13, wherein the secondary reflector is a cylindrical fresnel reflector.

21-22. (canceled)

23. Apparatus according to claim 13, wherein light reflected from the secondary reflector does not pass through the beam axis.

24-25. (canceled)

26. A reflector comprising a generally tubular internally reflective body arranged along a longitudinal axis and having a light output aperture and a source entry aperture, said reflector adapted to receive a light source through said source input aperture, and to generate a beam from said light output aperture, wherein said reflector comprises a rear dished region having a varying cross section, and a forward prismatic region having a substantially constant cross section.

27. A reflector according to claim 26, wherein said forward region is axially longer than said rear region.

28. A reflector according to claim 26, wherein said rear region is a paraboloid or an ellipsoid.

29. A reflector according to claim 28, wherein the ratio of the focal length of the rear region to the maximum radius of the rear region is greater than 0.4.

30. A reflector according to claim 28, wherein the ratio of the focal length of the rear region to the maximum radius of the rear region is substantially 0.5.

31. A reflector according to claim 26, wherein said forward portion reflects incident light from said rear portion back towards said rear portion.

32. A reflector assembly according to claim 26, wherein said forward portion comprises a plurality of stepped, axially spaced reflecting facets.
